(19) United States
(12) Patent Application Publication
(10) Pub. No.: US 2012/0237891 A1
(43) Pub. Date: Sep. 20, 2012

(54) TEMPOROMANDIBULAR JOINT DISLOCATION REDUCTION ROLLER

(76) Inventor: Liansheng SONG, Farmington, CT (US)

(21) Appl. No.: 13/051,353

(22) Filed: Mar. 18, 2011

(51) Int. Cl. A61C 19/00

(52) U.S. Cl. 433/73; 433/24

(57) ABSTRACT

A medical/dental instrument that is a temporomandibular joint dislocation reduction roller is provided. The temporomandibular joint dislocation reduction roller assists reduction of a dislocated temporomandibular joint. The temporomandibular joint dislocation reduction roller reduces the risk of injury to the patient as well as to the health care professional during the reduction procedure. A method for using the temporomandibular joint dislocation reduction roller for efficient reduction of an anterior dislocation of the temporomandibular joint is also provided.

### BACKGROUND OF THE DISCLOSURE

1. Field of Disclosure

A medical/dental instrument that is a temporomandibular joint dislocation reduction roller for reduction of an anterior dislocation of the temporomandibular joint (TMJ) is provided, and a method of using that instrument.

2. Description of Related Art

Temporomandibular joint (TMJ) dislocation is a medical disorder that generally requires immediate medical attention. Temporomandibular joint dislocations may be acute, chronic, or recurrent. TMJ dislocations may spontaneously result from opening the mouth too wide, as when taking too large a bite of food, laughing or yawning. TMJ dislocations may also occur during dental procedures (e.g., tooth extraction), orotracheal procedures (e.g., intubation), trauma, or a seizure.

The temporomandibular joint is the site of articulation between the condyle of the mandible (lower jaw) and the squamous portion of the temporal bone of the cranium. The temporomandibular joint is the most complex joint, both morphologically and functionally, in the human body. Morphologically, the temporomandibular joint is made of two completely separate joints that are connected by the mandible into one unit. Each joint has a disk that separates the joint into two spaces, which are the upper and lower joint spaces. Four distinct articulations are required to move together to perform the functions of the joint. Functionally, the temporomandibular joint is used for opening and closing the mouth, mandibular protrusion and retrusion, and mandibular lateral shift. The temporomandibular joint is used for mastication (chewing), deglutition (swallowing), speech, and other functions.

A common dislocation of the temporomandibular joint is an acute anterior dislocation. An acute TMJ dislocation is typically treated in a hospital emergency department, oral and maxillofacial surgery clinic, dental clinic, ENT clinic, or plastic surgery clinic for immediate treatment. The patient with TMJ dislocation often has jaw pain, trismus, and may have difficulty speaking or swallowing, and malocclusion. Commonly, TMJ dislocation is bilateral, with a symmetrically open position. Less frequently, there is unilateral dislocation, with deviation of the mandible to the unaffected side.

Upon physical examination of a patient with TMJ dislocation, a health care professional will often detect an absence of the condyle from the glenoid fossa, with a visible and palpable preauricular depression. The patient is unable to close the mouth or move the mandible, except to open the mouth wider in a purely rotational manner. In cases of lateral dislocation, the condylar head can sometimes be felt in the temporal space.

Reduction of a dislocated temporomandibular joint is conventionally done by manual manipulation performed by a health care professional. Both intraoral and extraoral reduction techniques are used for manual manipulation, with intraoral techniques being more common.

However, conventional intraoral and extraoral techniques for manual reduction of a dislocated TMJ have a number of disadvantages. Reduction of a dislocated TMJ in patients having strong mastication musculatures, muscle spasms and/or a long-term medical history of TMJ dislocations may have high failure rates, even with great efforts by the health care professional. When conventional reduction techniques fail, the management of a dislocated TMJ becomes more difficult, and may require giving the patient local anesthesia or sedation for further manipulation. In more complicated situations, reduction of the dislocated temporomandibular joint may require general anesthesia with muscle relaxation, or even open joint surgery.

Another disadvantage of conventional approaches for intraoral reduction of a dislocated TMJ is the risk of injury to the hands and fingers of the health care professional from the patient's reflexive, involuntary bite during reduction. A bite injury also can increase the risk of exposure to transmittable diseases, such as hepatitis, HIV/AIDS, or other viral or bacterial infections. A further disadvantage of conventional approaches for reduction of a dislocated TMJ is the discomfort to the patient from having one or both hands of the health care professional in the mouth of the patient.

### SUMMARY OF THE DISCLOSURE

The present disclosure provides a medical/dental instrument that is a temporomandibular joint (TMJ) dislocation reduction roller for efficient reduction of an anterior dislocation of the temporomandibular joint.

The temporomandibular joint dislocation reduction roller of the present disclosure is an integrated body having a handle, a shank, and a cushion around a distal portion of the shank. The diameter of the distal portion of the shank can be enlarged relative to the rest of the shank to accommodate various sizes of mouth openings of patients with a dislocated TMJ.

The temporomandibular joint dislocation reduction roller assists the reduction of a dislocated TMJ by functioning as a fulcrum when upward pressure is applied to the chin, as well as a roller and sender when the temporomandibular joint dislocation reduction roller is turned between the teeth of the patient.

The temporomandibular joint dislocation reduction roller is re-usable, and can be easily sterilized after use.

The present disclosure further provides a method for reduction of a dislocated TMJ using the temporomandibular joint dislocation reduction roller. The method provides a good success rate for in reduction of a dislocated TMJ, and requires less effort and time for reduction than conventional intraoral and extraoral approaches described above.

The temporomandibular joint dislocation reduction roller of the present disclosure is safer for the patient, by reducing the risk of injuries to the patient's teeth, tongue, oral soft tissue, and/or airway, as compared with non-specific equipment selected by “trial and error.”

The temporomandibular joint dislocation reduction roller is also safer for the health care professional, by reducing the risk of injuries to the hands and fingers of the health care professional caused by the strong, involuntary biting reflex during reduction.

### BRIEF DESCRIPTION OF THE DRAWINGS

FIG. 1 is a perspective view of an exemplary embodiment of a temporomandibular joint (TMJ) dislocation reduction roller of the present disclosure.

FIGS. 2A to 2C are left side views of three different exemplary embodiments of the temporomandibular joint dislocation reduction roller of FIG. 1 that have different diameters at the distal (unconnected) end of the shank.

FIG. 3 is a right side view illustrating anatomic placement of a temporomandibular joint dislocation reduction roller of FIG. 1, prior to reduction of a dislocated TMJ.

FIGS. 4A to FIG. 4C represent a series of right side views of an anatomic diagram that illustrates an exemplary embodiment of a method for reduction of an anteriorly dislocated TMJ using a temporomandibular joint dislocation reduction roller of FIG. 1.

### DETAILED DESCRIPTION OF THE DISCLOSURE

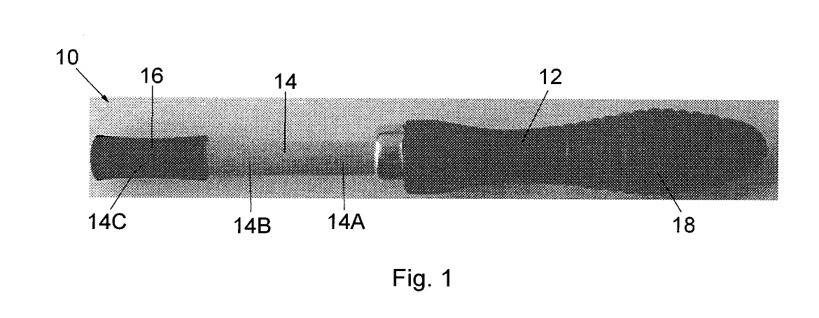

Referring to the drawings, and in particular, FIG. 1, there is provided a temporomandibular joint (TMJ) dislocation reduction roller, generally represented by reference number 10, for efficiently reducing a dislocated temporomandibular joint. TMJ dislocation reduction roller 10 is a medical/dental instrument having a handle 12, a shank 14 that is connected on one end to handle 12, and a cushion 16 that is connected to a distal portion (i.e., the unconnected end) of shank 14. Handle 12, shank 14, and cushion 16 form an integral instrument.

Handle 12 is used to grip and provide torsion to TMJ dislocation reduction roller 10. Handle 12 can be made of any solid material, including plastic, wood, metal, or any combinations thereof. In a preferred exemplary embodiment, handle 12 is made of plastic. In another exemplary embodiment, handle 12 is made of stainless steel. As shown in FIGS. 1 to 4, handle 12 has a cross-section that is generally circular, and can have a curved profile to fit the hand of the user, such as a health care professional, to provide a better grip. Grooves 18 may also be present on the exterior surface of handle 12, as shown in FIG. 1, to improve the grip and feel of TMJ dislocation reduction roller 10 for the user.

Shank 14 has a proximal portion 14A that is connected to handle 12, a distal portion 14C of shank 14 that is farthest from handle 12, and a medial portion 14B of shank 14 that extends between proximal portion 14A and distal portion 14C. In a preferred embodiment, shank 14 is made of stainless steel.

Shank 14 is fixed to handle 12 so that there is no movement or twisting of the shank with respect to the handle. In a preferred embodiment, temporomandibular dislocation reduction roller 10 has a handle 12 that is plastic, shank 14 that is stainless steel, and cushion 16 that is rubber. In another embodiment, shank 14 and handle 12 are stainless steel. In all embodiments, shank 14 and handle 12 form a single piece, whether by being integrally formed or connected together so that they are unattachable.

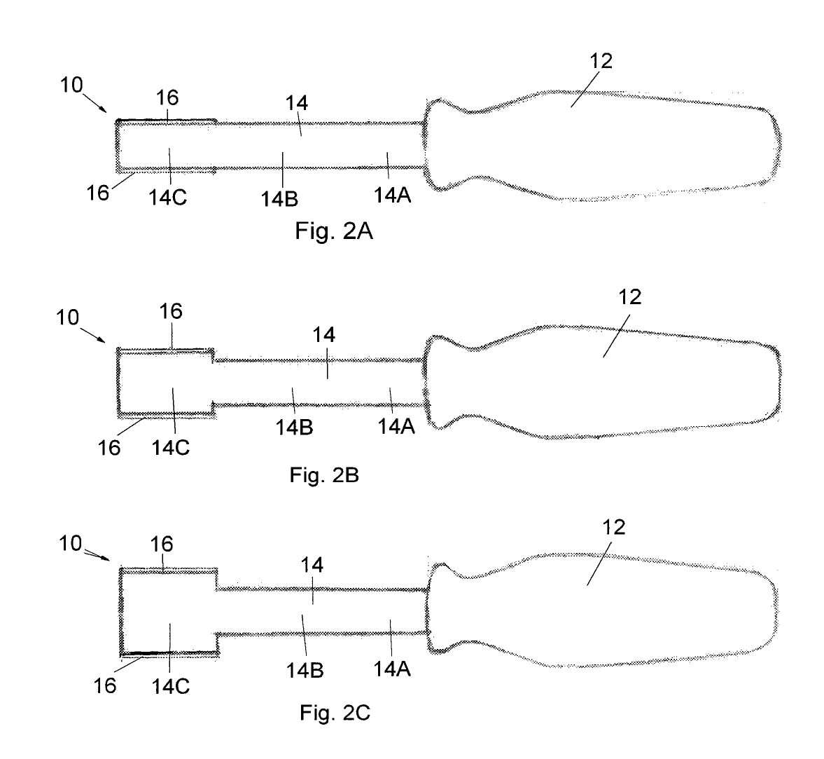

The diameter of distal portion 14C of shank 14 can be enlarged in relation to the other portions of shank 14, namely proximal portion 14A and medial portion 14B, to provide TMJ dislocation reduction rollers that are sized to fit patient mouths of varied sizes. In the exemplary embodiment shown in FIG. 2A, the diameter of distal portion 14C of shank 14 is the same diameter as proximal portion 14A and medial portion 14B. However, in two other exemplary embodiments, which are shown in FIGS. 2B and 2C, the diameter of distal portion 14C is larger than the diameter of proximal portion 14A or medial portion 14B of shank 14. The different sizes of the distal end of TMJ dislocation reduction roller 10 permit the user to select a roller size that fits the mouth of the patient.

As shown in FIG. 1 and FIGS. 2A to 2C, shank 14 has an exterior surface that is smooth along the entire length. However, in an alternative embodiment, proximal portion 14A and medial portion 14B are smooth, but distal portion 14C of shank 14 has an exterior surface that is roughened by ridges, grooves, knurling, or other cuts or protrusions (not shown) to increase surface contact of distal portion 14C with cushion 16 and to further prevent slippage of the cushion on the distal portion.

Cushion 16 is disposed on part or all of distal portion 14C of shank 14 to protect and cushion the patient's teeth when TMJ dislocation reduction roller 10 is positioned in a patient's mouth during reduction. Cushion 16 can extend over the edge of distal portion 14C to cover the end of shank 14. Cushion 16 is made of a flexible, elastic material, including, but not limited to, rubber, foam, or combinations thereof. In a preferred embodiment, cushion 16 is made of rubber. The exterior surface of cushion 16 can be smooth. Alternatively, part or all of the exterior surface of cushion 16 may be roughened with ridges, grooves, knurling, or other cuts or protrusions (not shown) that increase surface contact of cushion 16 with the patient's teeth to improve movement of the patient's mandible when turning TMJ dislocation reduction roller 10 in the patient's mouth during reduction.

Cushion 16 can be permanently adhered to distal portion 14C of shank 14. Alternatively, cushion 16 can be removably connected to distal portion 14C, so that the cushion can be removed after use for cleaning and/or for replacement.

In each of the exemplary embodiments shown in FIGS. 2A to 2C, handle 12 is about 90 mm in length, and about 30 mm in diameter at its widest point. Shank 14 extends from handle 12 for a length of about 80 mm. Cushion 16 is about 25 mm in length and about 1.5 mm thick, and covers part or all of distal portion 14C of shank 14. However, as described above, TMJ dislocation reduction roller 10 can have different diameters at distal portion 14C of shank 14, so that the user can select the size that best suits the mouth size of the patient. For example, in FIG. 2A, the diameter of proximal portion 14A and medial portion 14B of shank 14 are each about 12 mm, and the diameter of distal portion 14C is exactly the same (12 mm). However, in FIG. 2B, while proximal portion 14A and medial portion 14B of shank 14 each have a diameter of about 12 mm, distal portion 14C has an enlarged diameter of about 16 mm. In FIG. 2C, proximal portion 14A and medial portion 14B of shank 14 each have a diameter of about 12 mm, while distal portion 14C of shank 14 is enlarged further to a diameter of about 20 mm.

TMJ dislocation reduction roller 10 can be used by a health care professional to reduce a bilateral anterior dislocation of the temporomandibular joint one side at a time. Thus, the length of the instrument does not have to extend across both sides of the patient's mouth.

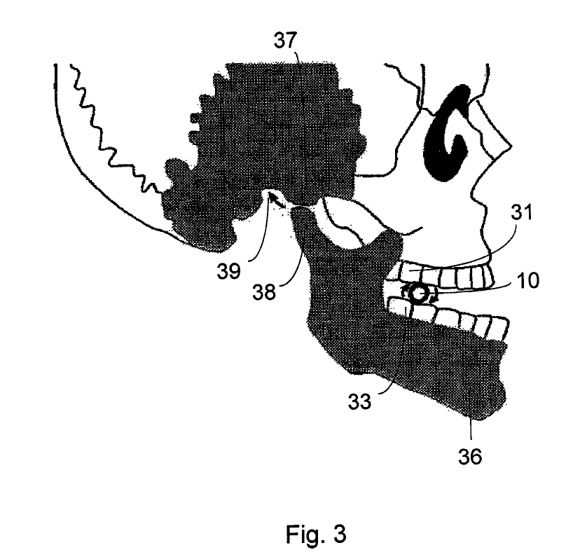

Referring now to FIG. 3, an illustration is provided to show a TMJ dislocation reduction roller of the present disclosure positioned between one or more molars 31 in the patient's upper jaw and one or more molars 33 in the patient's lower jaw (mandible) 34 during reduction of the dislocation. Condyle 38 is shown in a dislocated position and locked with condylar eminence 37. TMJ dislocation reduction roller 10 is initially placed as far back as possible in the patient's mouth while remaining between the patient's upper and lower molars 31, 33. When an upward force is applied to the patient's chin 36, TMJ dislocation reduction roller 10 acts as a fulcrum, so that the upward force applied to chin 36 causes condyle 38 to move downward (away) from condylar eminence 37. Then, when the user manually turns the handle of TMJ dislocation reduction roller 10 in a clockwise direction to reduce a TMJ dislocation on the patient's right side (as shown in FIG. 3), and in a counterclockwise direction to reduce a TMJ dislocation on the patient's left side (not shown), mandible 34 is rolled posteriorly, causing condyle 38 to move to its normal anatomic position in glenoid fossa 39, completing a successful reduction.

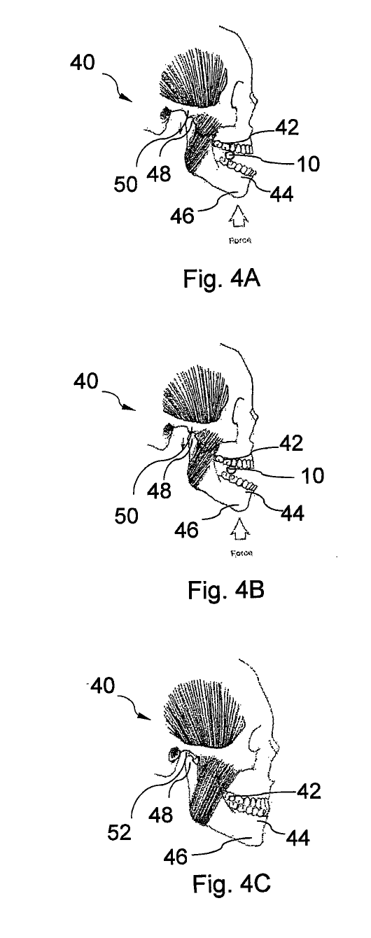

FIGS. 4A to 4C are a series of diagrams that illustrate an exemplary method of the present disclosure, generally represented by reference number 40, that uses TMJ dislocation reduction roller 10 for reduction of an anterior dislocation of a temporomandibular joint.

Method 40 includes positioning TMJ dislocation reduction roller 10 between one or more teeth of the patient's upper jaw 42 and one or more teeth of the patient's mandible 44. The cushion of the temporomandibular joint dislocation reduction roller directly contacts one or more molars of mandible 44. The handle of the temporomandibular joint dislocation reduction roller is held by one hand of the health care professional, and placed the other (second) hand on the patient's chin 46. The health care professional then applies an upward force to chin 46 in the direction of the arrow in FIGS. 4A and 4B. When the upward force is applied, the temporomandibular joint dislocation reduction roller acts as a fulcrum, causing the (dislocated) condyle 48 to move downward and away from the anterior portion of condylar eminence 50.

As mentioned above, upon detecting that the dislocated TMJ condyle is slightly mobile (indicating that condyle 48 is free of locking with condylar eminence 50), the health care professional's first hand begins turning the handle of temporomandibular joint dislocation reduction roller 10 in the patient's mouth (turning in a clockwise direction to reduce a TMJ dislocation on the patient's right side, and turning in a counterclockwise direction to reduce a TMJ dislocation on the patient's left side), as illustrated for the right side in FIGS. 4B and 4C, forcing mandible 44 to move backward in a posterior direction. The movement of mandible 44 permits condyle 48 to regain its normal anatomic position in glenoid fossa 52, completing the reduction of the dislocated TMJ. When turned by the user, temporomandibular joint dislocation reduction roller 10 serves both as a roller of mandible 44 and as a sender of condyle 48 back to its normal anatomic position.

Thus, the temporomandibular joint dislocation reduction roller of the present disclosure operates as a combination of fulcrum, roller and sender when used in method 40 for reduction of a dislocated TMJ.

As used in this application, TMJ reduction method 40 may be called the “rolling reduction method” or “rolling reduction technique” with no change in meaning.

TMJ reduction method 40 is simple and effective for reduction of most anterior dislocations of the TMJ, having fewer failed reductions and requiring less effort and time as compared with conventional manual reduction techniques. The success rate of the present method for reduction of a dislocated TMJ provides the further advantage of reducing the need for local anesthesia, IV sedatives, and/or general anesthesia to be given to patients for manual reduction as compared with conventional approaches that employ manual manipulation only. In addition, the present method avoids having the health care professional place one or both of his/her hands in the patient's mouth for reduction, and requires less time to complete the reduction, both of which decrease the discomfort of the patient as compared with conventional reduction approaches.

TMJ reduction method 40 combines intraoral and extraoral approaches for reduction of a dislocated TMJ. Intraorally, a TMJ dislocation reduction roller is placed in the patient's mouth, rather than the hands or fingers of the health care professional, thereby reducing or avoiding bite injuries to the hands and fingers caused by the strong, involuntary biting reflex of patients during reduction. Avoiding bite injuries also reduces the risk of exposure of the health care professional to transmittable diseases, such as hepatitis, HIV/AIDS, as well as other viral and bacterial infections.

The temporomandibular joint dislocation reduction roller of the present disclosure provides health care professionals, and other users, with a standardized instrument to assist with reduction of a dislocated TMJ, and avoids the use of a random instrument selected by “trial and error.”

Temporomandibular joint dislocation reduction roller 10 and rolling reduction method 40 also improve the safety of the patient by avoiding injuries to the tongue, teeth, trauma to the mouth or other soft tissues, and/or airway injuries from foreign bodies that can result from using non-specific instruments selected by “trial and error” for reduction of a dislocated TMJ.

TMJ dislocation reduction roller 10 is a reusable instrument, and can easily be sterilized after use.

TMJ dislocation reduction roller 10 is a simple instrument, and offers the advantage of low manufacturing costs.

As used in this application, the terms “reduction,” “reduce,” and “reducing” mean the restoration of a dislocated part to its normal anatomical position.

As used in this application, the word “about” for dimensions, weights, and other measures means a range that is ±10% of the stated value, more preferably ±5% of the stated value, and most preferably ±1% of the stated value, including all subranges therebetween.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances that fall within the scope of the disclosure.

What is claimed is:

1. An instrument to assist with manual reduction of a dislocated temporomandibular joint, said instrument comprising:
a handle;
a shank extending from said handle, said shank having a proximal portion fixedly connected to said handle, and a distal portion; and
a cushion disposed on said distal portion of said shank.

2. The instrument according to claim 1, wherein said distal portion and said proximal portion of said shank have equal diameters.

3. The instrument according to claim 2, wherein said distal portion and said proximal portion of said shank each have diameters of about 12 mm.

4. The instrument according to claim 1, wherein said distal portion of said shank has a larger diameter than said proximal portion of said shank.

5. The instrument according to claim 4, wherein said distal portion of said shank has a diameter of about 16 mm and said proximal portion of said shank has a diameter of about 12 mm.

6. The instrument according to claim 4, wherein said distal portion of said shank has a diameter of about 20 mm and said proximal portion of said shank has a diameter of about 12 mm.

7. The instrument according to claim 1, wherein said handle is plastic.

8. The instrument according to claim 1, wherein said shank is stainless steel.

9. The instrument according to claim 1, wherein said cushion is rubber.

10. The instrument according to claim 1, wherein said handle and said shank are an integral body.

11. A method for using a temporomandibular joint (TMJ) dislocation reduction roller for reduction of a dislocated temporomandibular joint in a patient, wherein said temporomandibular joint dislocation reduction roller comprises a handle, a shank fixedly connected to said handle, and a cushion disposed on said shank at an end opposite said handle, the method comprising:
placing said temporomandibular joint dislocation reduction roller in a mouth of the patient between one or more molar teeth of the patient's upper jaw and one or more molar teeth of the patient's mandible;
applying an upward force to a chin of the patient to displace a condyle of the patient downward and away from a condylar eminence of the patient; and
turning said temporomandibular joint dislocation reduction roller in the patient's mouth to move said mandible in a posterior direction,
wherein said applying of said upward force and said turning of said TMJ dislocation reduction roller achieve said reduction of said dislocated temporomandibular joint by permitting said condyle to return to a normal anatomic position.

12. The method according to claim 11, wherein said temporomandibular joint dislocation reduction roller operates as a fulcrum when said upward force is applied to said chin.

13. The method according to claim 11, wherein said temporomandibular joint dislocation reduction roller operates as a roller of said mandible and as a sender of said condyle to its normal anatomic position when turning said temporomandibular joint dislocation reduction roller.

14. The method according to claim 11, wherein each of said placing, applying, and turning steps are performed by a user performing a manual reduction of said temporomandibular joint dislocation.

15. A method for reduction of a dislocated temporomandibular joint in a patient, comprising:
placing a temporomandibular joint dislocation reduction roller in a mouth of said patient to contact one or more molars of an upper jaw and one or more molars of a mandible of said patient, said temporomandibular joint dislocation reduction roller comprising:
a handle;
a shank extending from said handle, said shank having a proximal portion fixedly connected to said handle, and a distal portion; and
a cushion disposed on said distal portion of said shank;
applying an upward force to a chin of the patient to displace a condyle of the patient downward and away from a condylar eminence of the patient; and
turning said temporomandibular joint dislocation reduction roller to move said mandible in a posterior direction to permit said condyle to return to a normal anatomic position.

16. The method according to claim 15, wherein said distal portion of said shank and said cushion form a fulcrum when said upward force is applied to said chin.

17. The method according to claim 15, wherein said proximal portion and said distal portion of said shank have equal diameters.

18. The method according to claim 15, wherein said distal portion of said shank has a larger diameter than said proximal portion of said shank.
